(19) United States
(12) Patent Application Publication
(10) Pub. No.: US 2009/0169986 A1
(43) Pub. Date: Jul. 2, 2009

(54) NON-AQUEOUS SECONDARY BATTERY AND METHOD FOR PRODUCING THE SAME

(76) Inventors: Masao FUKUNAGA, Osaka (JP); Hajime NISHINO, Nara (JP)

Correspondence Address: MCDERMOTT WILL & EMERY LLP, 600 13TH STREET, NW, WASHINGTON, DC, 20005-3096, US

(21) Appl. No.: 12/342,172

(22) Filed: Dec. 23, 2008

(30) Foreign Application Priority Data
Dec. 28, 2007 (JP) 2007-340741

(51) Int. Cl. H01M 2/14; H01M 10/04

(52) U.S. Cl. 429/144; 156/184; 156/256

(57) ABSTRACT

In a non-aqueous secondary battery that includes a strip-shaped positive electrode, a strip-shaped negative electrode, a first insulating layer interposed between the positive electrode and the negative electrode, and a non-aqueous electrolyte, the width of the positive electrode is smaller than the width of the negative electrode, both longitudinal end faces of the positive electrode are coated with a second insulating layer, and the first insulating layer and the second insulating layer are both porous.

### FIELD OF THE INVENTION

The present invention relates to a non-aqueous secondary battery, and more particularly to an improvement of insulating layers formed on positive electrodes.

### BACKGROUND OF THE INVENTION

At an increasing rate, more and more electronic devices have become cordless and portable in recent years, and demand for small and lightweight yet high energy density secondary batteries is increasing as a power source for such electronic devices. Not only for small consumer applications, technical development of large secondary batteries for applications that require durability and safety over a long period of time, such as electricity storage applications and electric vehicle applications, is also accelerating.

Non-aqueous secondary batteries, particularly lithium ion secondary batteries, are considered to have potential as a power source for devices as described above because they can provide high voltage and high energy density.

Typically, a non-aqueous secondary battery includes a positive electrode, a negative electrode, a separator interposed between the positive electrode and the negative electrode, and a non-aqueous electrolyte. The separator has a function for electrically insulating the positive electrode and the negative electrode from each other, and a function for retaining the non-aqueous electrolyte. In the case of a lithium ion secondary battery, for example, a microporous film containing a resin material is used as the separator. As the resin material, polyolefins such as polyethylene and polypropylene are used.

However, separators containing a resin material are likely to contract under high temperature conditions. Thus, if the battery is pierced with a sharp object such as a nail, the separator will contract due to heat generated by short circuit. As a result, the short-circuited portion spreads, generating further heat, and accelerating excessive heating of the battery.

Under such circumstances, in order to improve battery safety, a technique in which a highly heat resistant porous insulating layer made of an inorganic solid particle and a polymer is used as a separator has been proposed. The porous insulating layer is attached onto both surfaces of a positive electrode or negative electrode. However, the width of positive electrodes is usually smaller than that of negative electrodes. Accordingly, if the insulating layer is formed only on both surfaces of a positive electrode, the longitudinal end faces of the positive electrode where the insulating layer is not formed may come into contact with the negative electrode, causing an internal short-circuit. If the battery undergoes vibrations or an impact, the possibility of occurrence of internal short circuit increases even more.

In order to suppress such internal short circuit, Patent Document 1 (Japanese Laid-Open Patent Publication No. 2005-190912) proposes to coat the bottom faces of an electrode group obtained by laminating or spirally winding a positive electrode and a negative electrode using an insulating material. According to Patent Document 1, it is possible to suppress the electrode plates from moving due to vibrations or an impact, so that battery safety can be improved.

However, when the bottom faces of an electrode group are coated with an insulating material as in Patent Document 1, it is difficult to coat the entire longitudinal end faces of the positive electrode, which is small in width, with the insulating material, and thus a portion that is not coated with the insulating material may remain. As a result, the end face of the positive electrode that is not coated with the insulating material may come into contact with the negative electrode, causing internal short circuit.

Furthermore, when the entire bottom faces of an electrode group are coated with an insulating material as in Patent Document 1, non-aqueous electrolyte does not easily permeate into the electrode group, lowering the productivity of the battery.

### BRIEF SUMMARY OF THE INVENTION

The present invention provides a non-aqueous secondary battery including a strip-shaped positive electrode, a strip-shaped negative electrode, a first insulating layer interposed between the positive electrode and the negative electrode, and a non-aqueous electrolyte, wherein the width of the positive electrode is smaller than the width of the negative electrode, both longitudinal end faces of the positive electrode are coated with a second insulating layer, and the first insulating layer and the second insulating layer are both porous.

As used herein, “the width of the positive electrode” refers to the length in the widthwise direction of the positive electrode. In the present invention, the length in the widthwise direction of the positive electrode is shorter than the length in the widthwise direction of the negative electrode. It is also preferable that the length in the longitudinal direction of the positive electrode is shorter than the length in the longitudinal direction of the negative electrode.

The first insulating layer includes at least one selected from a porous resin film and an inorganic oxide particle film. In the case of the inorganic oxide particle film, it includes an inorganic oxide particle and a binder, and is attached to both surfaces of the positive electrode.

It is preferable that the first insulating layer includes both the inorganic oxide particle film and the porous resin film.

It is preferable that at least one of the widthwise end faces of the positive electrode is coated with a third insulating layer.

According to an embodiment of the present invention, at least one of the second insulating layer and the third insulating layer contains the same material as the constituent material of the inorganic oxide particle film. That is, at least one of the second insulating layer and the third insulating layer may be an insulating layer containing an inorganic oxide particle and a binder.

According to an embodiment of the present invention, the third insulating layer is made of insulation tape.

The present invention is particularly effective when the negative electrode contains, as a negative electrode active material, at least one selected from the group consisting of silicon, a silicon alloy, a silicon oxide and a silicon nitride.

The present invention further provides a method for producing a non-aqueous secondary battery including the steps of: (i) intermittently forming positive electrode material mixture layers on both surfaces of a positive electrode current collector sheet to form a positive electrode continuum; (ii) applying a first paste containing an inorganic oxide particle, a binder and a liquid component on a surface of the positive electrode material mixture layers, followed by drying to remove the liquid component to form a first insulating layer; (iii) cutting the positive electrode continuum to obtain a strip-shaped positive electrode; (iv) coating both longitudinal end faces of the positive electrode with a second insulating layer; and (v) laminating or spirally winding the positive electrode having the first insulating layer and the second insulating layer and a negative electrode with the first insulating layer interposed therebetween to form an electrode group.

In the production method of the present invention, it is possible to form, in the step (iv), the second insulating layer with a second paste containing the same material as the constituent material of the first paste.

It is preferable that the second paste has a higher binder content than the first paste.

The present invention further provides a method for producing a non-aqueous secondary battery including the steps of: (a) intermittently forming positive electrode material mixture layers on both surfaces of a positive electrode current collector sheet to form a positive electrode continuum; (b) cutting the positive electrode continuum to obtain a strip-shaped positive electrode; (c) applying a paste containing an inorganic oxide particle, a binder and a liquid component onto the positive electrode such that the application width is larger than the width of the positive electrode, followed by drying to remove the liquid component so as to coat both surfaces of the positive electrode and both longitudinal end faces of the positive electrode with a first insulating layer and a second insulating layer, respectively; and (d) laminating or spirally winding the positive electrode having the first insulating layer and the second insulating layer and a negative electrode with the first insulating layer interposed therebetween to form an electrode group.

It is preferable that the production methods of the present invention further include a step X of further coating at least one of the widthwise end faces of the positive electrode with a third insulating layer.

In the step X, it is preferable to form the third insulating layer by coating the widthwise end face with insulation tape.

According to the present invention, it is possible to obtain a non-aqueous secondary battery that can achieve both high productivity and excellent safety.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1A is a top view schematically illustrating a positive electrode in the course of a production of a non-aqueous secondary battery.

FIG. 1B is a top view schematically illustrating a positive electrode in the course of a production of a non-aqueous secondary battery.

FIG. 1C is a top view schematically illustrating a positive electrode in the course of a production of a non-aqueous secondary battery.

FIG. 2 is a top view schematically illustrating a positive electrode according to an embodiment of the present invention.

FIG. 3 is a vertical cross-sectional view of a cylindrical non-aqueous secondary battery.

### DETAILED DESCRIPTION OF THE INVENTION

A non-aqueous secondary battery of the present invention includes a strip-shaped positive electrode, a strip-shaped negative electrode, a first insulating layer that is porous and is interposed between the positive electrode and the negative electrode, and a non-aqueous electrolyte. The positive electrode and the negative electrode are laminated or spirally wound with the first insulating layer interposed therebetween to form an electrode group. The positive electrode includes a strip-shaped positive electrode current collector and a positive electrode active material layer carried on the positive electrode current collector. The negative electrode includes a strip-shaped negative electrode current collector and a negative electrode active material layer carried on the negative electrode current collector. Thus, ordinarily, the positive electrode current collector is exposed at the longitudinal and widthwise end faces of the positive electrode.

The width of the positive electrode is smaller than that of the negative electrode. For this reason, the longitudinal end faces of the positive electrode easily come into contact with the negative electrode if the positive electrode and the negative electrode move out of position with each other as a result of an impact such as being dropped. However, both longitudinal end faces of the positive electrode are coated with a second insulating layer that is porous. Accordingly, internal short circuit does not occur even if the longitudinal end faces of the positive electrode come into contact with the negative electrode. Because the second insulating layer does not coat the entire bottom faces of the electrode group and is porous, it does not significantly interfere with the permeability of non-aqueous electrolyte into the electrode group.

The first insulating layer includes at least one selected from a porous resin film and an inorganic oxide particle film. The inorganic oxide particle film is attached onto both surfaces of the positive electrode, and has a function for preventing short-circuited portions from spreading in the event of severe short circuit caused by, for example, being pierced with a nail. Accordingly, the inorganic oxide particle film needs to be made of a material that does not contract by reaction heat. It is desirable that the inorganic oxide particle film coats at least the surface of the positive electrode active material layer that faces the negative electrode, and most desirably, the inorganic oxide particle film coats both entire surfaces of the positive electrode.

The inorganic oxide particle film contains an inorganic oxide particle and a binder. With inclusion of an inorganic oxide particle, an inorganic oxide particle film having superior heat resistance and stability can be obtained. The inorganic oxide particle preferably contains, for example, alumina, magnesia, etc. from the viewpoint of electrochemical stability. It is preferable that the inorganic oxide particle has a volume based median diameter of, for example, 0.1 to 3 μm from the viewpoint of obtaining a film having appropriate porosity and thickness. These inorganic oxides may be used alone, or in combination of two or more.

Because the first insulating layer is porous, ions can migrate freely between the positive electrode and the negative electrode. The first insulating layer thus does not impede electrode reactions. It is preferable that the inorganic oxide particle film has a porosity of, for example, 40 to 80%, and more preferably 40 to 60%. If the porosity of the inorganic oxide particle film is less than 40%, permeation of non-aqueous electrolyte into the electrode group may be impeded by the insulating layer. Conversely, when the porosity of the inorganic oxide particle film is over 80%, the film strength may become insufficient.

The first insulating layer may or may not include a porous resin film. The porous resin film is a sheet-like film that is separate from the electrode and is composed primarily of a resin material. The porous resin film has a property of contracting at high temperatures. On the other hand, the porous resin film closes its pores at a temperature lower than the temperature at which it starts contracting, and thus the porous resin film can have a safety function for shutting down current flow. The porous resin film can be made of a material such as a polyolefin resin or aramid resin. Particularly, by using an aramid resin, it is possible to form a first insulating layer having a high heat resistance. The porous resin film has a thickness of, for example, 5 to 20 μm.

If the first insulating layer does not include the porous resin film, the inorganic oxide particle film functions as a separator. If the first insulating layer includes the porous resin film, it is preferable that the inorganic oxide particle film has a thickness of, for example, 2 to 5 μm. If the porous resin film is not included in the non-aqueous secondary battery, it is preferable that the inorganic oxide particle film has a thickness of, for example, 15 to 25 μm.

It is preferable that the amount of inorganic oxide particle contained in the inorganic oxide particle film is, for example, 50 wt % to 99 wt %. If the amount of inorganic oxide particle is less than 50 wt %, it may become difficult to control pores formed among inorganic oxide particles in the first insulating layer. Conversely, when the amount of inorganic oxide particle is over 99 wt %, the adhesion of the inorganic oxide particle film to the positive electrode lowers, and the inorganic oxide particle film may fall off from the positive electrode. It is more preferable that the amount of inorganic oxide particle contained in the inorganic oxide particle film is 90 to 99 wt %, and even more preferably 94 to 98 wt %.

It is preferable that the binder contained in the inorganic oxide particle film is highly heat resistant and amorphous. If internal short circuit occurs, short circuit reaction heat in excess of several hundreds of degrees centigrade may be generated locally. For this reason, it may not be appropriate to use a binder that is crystalline and has a low crystal melting point or a binder that is amorphous but has a low decomposition start temperature. If such binders are used, the inorganic oxide particle film may deform and the insulating layer may fall off from the positive electrode, and as a result, internal short circuit may further spread. It is preferable that the binder has a heat resistance of, for example, 300° C. or higher. An example of the binder is an elastomeric polymer containing an acrylonitrile unit.

The second insulating layer coats both longitudinal end faces of the positive electrode. By forming the second insulating layer on the longitudinal end faces of the positive electrode, it is possible to suppress the occurrence of internal short circuit in the battery caused by the end faces of the positive electrode coming into contact with the negative electrode. As used herein, “end face” refers to a cross section created by, ordinarily, cutting the positive electrode current collector and/or the positive electrode active material layer. The second insulating layer may be formed also on both end sides that are contiguous to the end faces (cross sections). Particularly when the end sides of the positive electrode are exposed portions of the positive electrode current collector that carry no positive electrode active material layer, it is preferable to form the second insulating layer on the end sides. In this case, it is preferable that the total thickness (thickness A) of the positive electrode current collector and the second insulating layers on the longitudinal end sides is equal to or lower than the total thickness (thickness B) of the positive electrode current collector, the positive electrode active material layers and the first insulating layers of a center portion of the positive electrode. If the thickness A is greater than the thickness B, when formed into an electrode group, the second insulating layer will close part of the bottom faces of the electrode group, and the permeability of non-aqueous electrolyte into the electrode group may lower.

Similar to the first insulating layer, the second insulating layer is porous. When the second insulating layer is porous, a non-aqueous electrolyte can easily permeate into the electrode group in the vicinity of the bottom faces of the electrode group. Furthermore, the porous second insulating layer can be formed in the same manner as the inorganic oxide particle film, and therefore it is possible to reduce equipment cost necessary to form the second insulating layer. The second insulating layer can be formed using the same material and composition as those of the inorganic oxide particle film. However, it is desirable that the second insulating layer has a binder content higher than that of the inorganic oxide particle film. For example, it is preferable that the binder content of the second insulating layer is 1.1 to 3 times the binder content of the inorganic oxide particle film. It is thereby possible to suppress the falling off of the second insulating layer from the longitudinal end faces of the positive electrode.

It is preferable that the second insulating layer has a porosity of, for example, 3 to 80%. If the porosity of the second insulating layer is less than 3%, the permeation of non-aqueous electrolyte into the electrode group may be impeded by the insulating layer. Conversely, if the porosity of the second insulating layer is over 80%, the film strength may become insufficient. The second insulating layer preferably has, but is not particularly limited to, a thickness of, for example, 1 μm or less, and more preferably, not less than 0.5 μm and not greater than 0.8 μm.

It is preferable that at least one of the widthwise end faces of the positive electrode is coated with a third insulating layer. By coating a widthwise end face with a third insulating layer, it is possible to suppress the occurrence of internal short circuit in the battery caused by the end face of the positive electrode coming into contact with the negative electrode. In this case as well, “end face” refers to a cross section created by cutting the positive electrode current collector and/or the positive electrode active material layer. The third insulating layer may be formed also on both end sides that are contiguous to the end faces (cross sections). It is desirable that the total thickness (thickness C) of the positive electrode current collector and the third insulating layers of the widthwise end sides is equal to or less than the total thickness (thickness D) of the positive electrode current collector, the positive electrode active material layers and the first insulating layers of a center portion of the positive electrode. If the thickness C is greater than the thickness D, when formed into an electrode group, the third insulating layer will exert pressure locally to the electrode group, and the electrode reactions may proceed nonuniformly.

The third insulating layer is effective particularly when producing a non-aqueous secondary battery without interposing a porous resin film between positive and negative electrodes.

The third insulating layer preferably has, but is not particularly limited to, a thickness of, for example, not less than 0.5 μm and not greater than 1 μm.

The third insulating layer does not need to be porous, but it may be porous. The third insulating layer that is porous can be formed in the same manner as the first insulating layer. However, it is desirable that the third insulating layer has a binder content higher than that of the first insulating layer at a level equal to that of the second insulating layer.

The third insulating layer may be insulation tape. With insulation tape, the third insulating layer can be formed easily, and as a result, the battery productivity can be improved.

There is no particular limitation on the material of the insulation tape, and for example, polypropylene (PP), polyphenylene sulfide (PPS), etc. can be used. Also, there is no particular limitation on the adhesive of the insulation tape, and for example, a butyl-based adhesive, an acryl-based adhesive, etc. can be used. An example of insulation tape having a butyl-based adhesive is insulation tape (product number: 466M) available from Teraoka Seisakusho Co., Ltd. An example of insulation tape having an acryl-based adhesive is insulation tape (product number: 4663) available from Teraoka Seisakusho Co., Ltd.

The positive electrode includes a positive electrode current collector and a positive electrode material mixture. The positive electrode material mixture contains a positive electrode active material as an essential component, and a binder and a conductive material as optional components.

As the positive electrode active material, for example, a lithium-containing composite metal oxide can be used. Examples of the lithium-containing composite metal oxide include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, Li₂MPO₄F, etc. (where M is at least one of Na, Mg, Sc, Y, Mn, Fe, Co, Ni, Cu, Zn, Al, Cr, Pb, Sb and B). Herein, 0≦x≦1.2, 0≦y≦0.9 and 2≦z≦2.3 are satisfied. The value of x represents a molar ratio of lithium, and this value varies during charge and discharge. It is more preferable that 0.8≦x≦1.1 and 0<y≦0.9 are satisfied. These positive electrode active materials may be used alone, or in combination of two or more.

There is no particular limitation on the binder of the positive electrode, and any conventionally known binder can be used, such as polyvinylidene fluoride (PVDF).

As the conductive material, for example, a carbon material can be used such as graphites including natural graphite, artificial graphite etc., and carbon blacks including acetylene black, ketjen black, channel black, furnace black, lamp black, thermal black, etc.

The negative electrode includes a negative electrode current collector and a negative electrode active material layer. The negative electrode active material layer contains a negative electrode active material as an essential component, and a binder and a conductive material as optional components.

The present invention is particularly effective when the negative electrode contains, as a negative electrode active material, at least one selected from the group consisting of silicon, a silicon alloy, a silicon oxide and a silicon nitride. These negative electrode active materials expand and contract to a relatively greater extent during charge and discharge, and thus it is difficult to form an inorganic oxide particle film on the negative electrode surface. For this reason, it is necessary to form an inorganic oxide particle film on the surface of the positive electrode whose width is smaller than that of the negative electrode. However, even when the negative electrode contains a negative electrode active material other than those listed above, the present invention is effective likewise.

It is preferable that, when the negative electrode contains, as a negative electrode active material, at least one selected from the group consisting of silicon, a silicon alloy, a silicon oxide and a silicon nitride, the negative electrode active material layer contains a plurality of columnar particles.

It is desirable that metal element M other than silicon contained in the silicon alloy includes a metal element that does not form an alloy with lithium. It is desirable that the metal element M is, for example, at least one selected from the group consisting of titanium, copper and nickel. The silicon alloy may contain one metal element M, or may contain a plurality of metal elements M.

It is desirable that the silicon oxide has a composition represented by general formula (1): SiOₓ (where 0<x<2). Likewise, it is desirable that the silicon nitride has a composition represented by general formula (2): SiN_{y} (where 0<y<4/3).

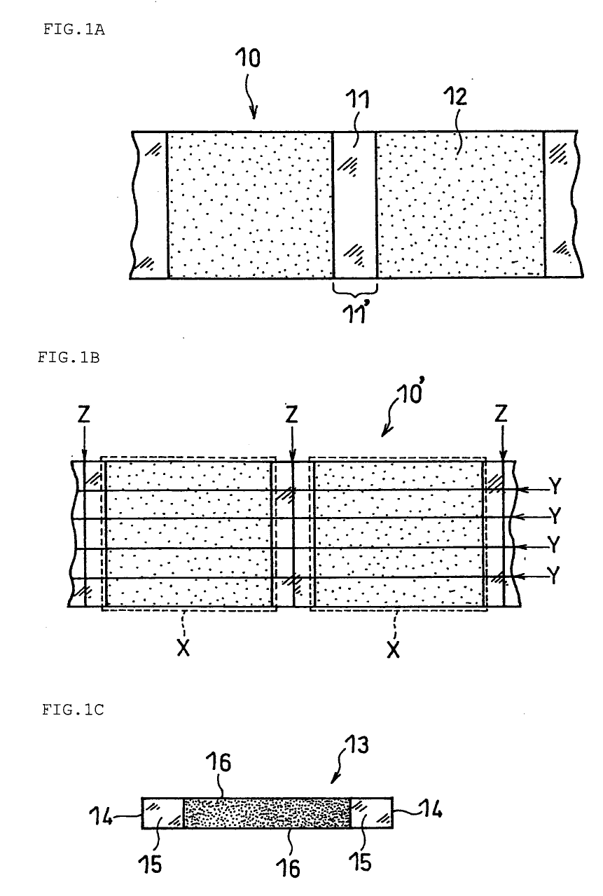

Hereinafter, a method for producing a non-aqueous secondary battery according to an embodiment of the present invention will be described with reference to the accompanying drawings. FIGS. 1A to 1C are top views schematically illustrating a positive electrode in the course of production of a non-aqueous secondary battery.

### Step (i)

First, positive electrode active material layers 12 are formed intermittently on both surfaces of a positive electrode current collector sheet 11 to form a positive electrode continuum 10. The positive electrode active material layers 12 are formed intermittently on the long positive electrode current collector sheet 11 according to the length of the positive electrode as shown in FIG. 1A. In the positive electrode continuum, exposed portions 11′ of the positive electrode current collector sheet that do not carry the positive electrode active material layer 12 remain.

### Step (ii)

Next, a first paste containing an inorganic oxide particle, a binder and a liquid component is applied onto the surface of a plurality of positive electrode active material layers (regions X shown in FIG. 1B), followed by drying to remove the liquid component, forming an inorganic oxide particle film as a first insulating layer. The first paste preferably has a solid concentration of 35 to 50wt %. The liquid component can be N-methyl-2-pyrrolidone (NMP), cyclohexanone (ANON), methylethylketone (MEK), xylene or the like alone, or it can be a mixture thereof. The drying temperature is preferably 80 to 130° C. It is desirable that the inorganic oxide particle film is formed such that it completely coats the positive electrode active material layer.

Step (iii)

Subsequently, the positive electrode continuum 10′ is cut, and thereby strip-shaped positive electrodes are obtained. The positive electrode continuum 10′ is cut, for example, along cutting lines Y and Z as shown in FIG. 1B according to the length of the positive electrode. Consequently, as shown in FIG. 1C, the cross section of the positive electrode current collector is exposed at the widthwise end faces 14 of the positive electrode 13, and the positive electrode current collector is also exposed at both end sides 15 that are contiguous to the cross sections. Usually, the cross section of the positive electrode current collector is also exposed at the longitudinal end faces 16 of the positive electrode 13, and the positive electrode current collector is also exposed at both end sides that are contiguous to the cross sections in many cases.

By cutting the positive electrode continuum on which inorganic oxide particle films are formed as described above, it is possible to readily form inorganic oxide particle films on a plurality of strip-shaped positive electrodes. Consequently, the productivity of non-aqueous secondary battery can be improved.

### Step (iv)

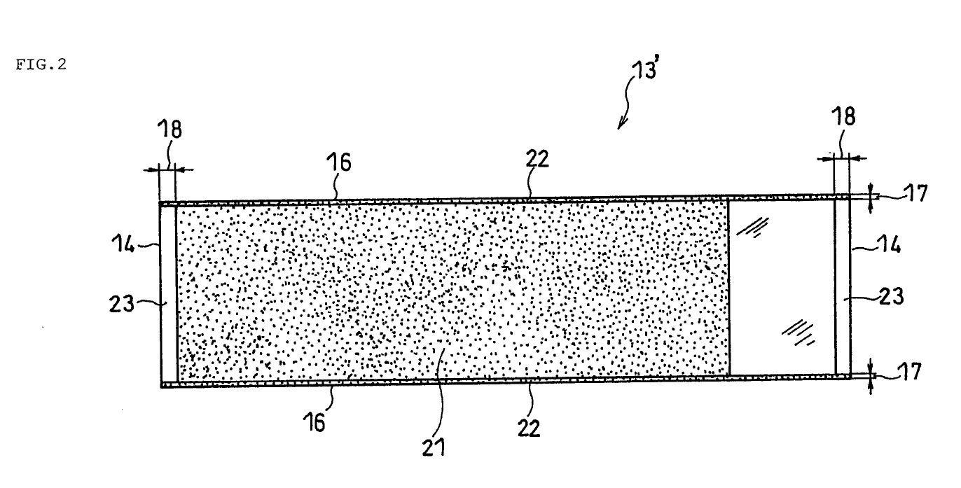

As shown in FIG. 2, in a positive electrode 13′ that carries an inorganic oxide particle film 21, both longitudinal end faces 16 are coated with a second insulating layer 22. At this time, it is desirable that the end sides 17 that are contiguous to the end faces 16 are also coated with the second insulating layer 22. The second insulating layer 22 can be formed by applying insulation tape, but it is easier to form the second insulating layer 22 by using a second paste containing the same material as the constituent material of the first paste used in step (ii). Alternatively, the second insulating layer 22 may be formed using the first paste as it is.

In step (iv), the second insulating layer 22 may be formed by using a second paste containing the same material as the constituent material of the first paste. Examples of the method for forming the second insulating layer 22 using the second paste include: a method in which the positive electrode is dipped in the second paste; a method in which the second paste is sprayed to the end faces of the positive electrode; a method in which the second paste is applied using a brush or the like, etc.

The second paste preferably contains a binder at a content higher than the first paste. It is preferable that the binder content of the second paste is, for example, 1.1 to 3 times the binder content of the first paste from the viewpoint of suppressing the falling off of the second insulating layer from the positive electrode.

### Step (v)

The positive electrode 13′ provided with first insulating layers 21 and second insulating layers 22, and a negative electrode are laminated or spirally wound with the first insulating layer 21 interposed therebetween to form an electrode group. The obtained electrode group is housed into a battery case, a non-aqueous electrolyte is allowed to permeate into the electrode group housed in the battery case, and the battery case is hermetically sealed. Thus, a battery is produced.

According to the production method of the present invention, before forming an electrode group in step (v), a porous inorganic oxide particle film is formed on a positive electrode in advance in steps (ii) to (iv). This can significantly improve the permeability of non-aqueous electrolyte into the electrode group. In contrast, when the bottom faces of an electrode group are coated with an insulating layer after the formation of the electrode group as is the case in conventional method, the permeability of non-aqueous electrolyte into the electrode group can be relatively small. In other words, with the production method of the present invention, the productivity of non-aqueous secondary battery is improved significantly.

Furthermore, it is preferable that at least one of the widthwise end faces 14 of the positive electrode is coated with a third insulating layer 23. At this time, it is desirable that the end side 18 that is contiguous to the end face 14 is also coated with the third insulating layer 23. By coating a widthwise end face of the positive electrode with a third insulating layer 23, short circuit between positive and negative electrodes can be suppressed more effectively. It is preferable to form the third insulating layer 23 by, for example, coating the widthwise end face with insulation tape.

A method for producing a non-aqueous secondary battery according to another embodiment will be described.

### Step (a)

Similar to step (i) described above, positive electrode active material layers are formed intermittently on both surfaces of a positive electrode current collector sheet to form a positive electrode continuum.

### Step (b)

Subsequently, the positive electrode continuum is cut to obtain strip-shaped positive electrodes. At the longitudinal end faces and the end sides that are contiguous to the end faces of a positive electrode, the positive electrode current collector is exposed. Likewise, the positive electrode current collector is also exposed at the widthwise end faces and the end sides that are contiguous to the end faces.

### Step (c)

Next, a paste containing an inorganic oxide particle, a binder and a liquid component is applied onto a cut positive electrode such that the application width of the paste is larger than the width of the positive electrode. The positive electrode is then dried to remove the liquid component, and as a result, an inorganic oxide particle film serving as a first insulating layer and a second insulating layer is formed on the positive electrode. The concentration of the solid in the paste is preferably 35 to 50 wt %. The liquid component can be N-methyl-2-pyrrolidone (NMP), cyclohexanone (ANON), methylethylketone (MEK), xylene or the like alone, or it can be a mixture thereof. The drying temperature is preferably 80 to 130° C. The inorganic oxide particle film is formed such that it completely covers the positive electrode active material layer and the longitudinal end faces of the positive electrode.

There is no particular limitation on the method for applying the paste onto a positive electrode performed in step (c). It is sufficient to, for example, apply the first paste using a die coater such that the application width of the paste is larger than that of the positive electrode. In step (c), because the paste is applied such that its application width is larger than the width of the positive electrode, the paste can be applied not only to the surface of the positive electrode, but also to the longitudinal end faces of the positive electrode. That is, both first and second insulating layers can be formed in a single step. Therefore, the productivity of non-aqueous secondary battery can be improved as compared to the case where first and second insulating layers are formed separately.

### Step (d)

The positive electrode provided with first insulating layers and second insulating layers, and a negative electrode are laminated or spirally wound with the first insulating layer interposed therebetween to form an electrode group. The obtained electrode group is housed into a battery case, a non-aqueous electrolyte is allowed to permeate into the electrode group housed in the battery case, and the battery case is hermetically sealed. Thus, a battery is produced.

It is also possible to coat at least one of the widthwise end faces of the positive electrode with a third insulating layer.

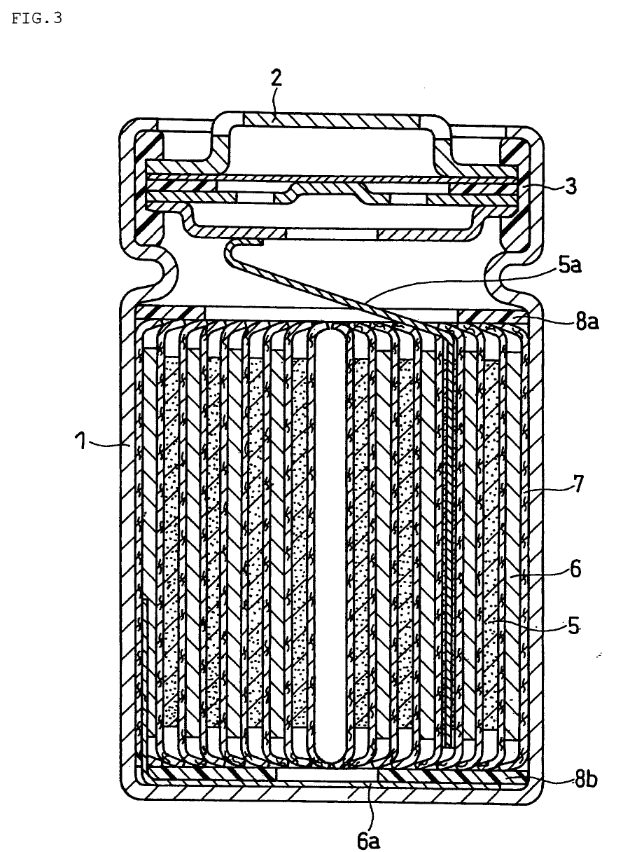

An example of a method for producing a cylindrical non-aqueous secondary battery will be described. FIG. 3 is a vertical cross-sectional view of a cylindrical non-aqueous secondary battery according to an embodiment of the present invention.

An upper insulating plate 8a and a lower insulating plate 8b are placed on the upper and lower portions of an electrode group, and the electrode group is inserted into a battery case 1. The positive electrode and the negative electrode have a positive electrode lead 5a and a negative electrode lead 6a, respectively, which have been attached before forming the electrode group. The other end of the negative electrode lead 6a is connected to the inner surface of the battery case 1, and the other end of the positive electrode lead 5a is welded to a sealing plate 2 equipped with an internal-pressure activated safety valve. Subsequently, a non-aqueous electrolyte is injected into the battery case 1 with a reduced-pressure method. The opening edge of the battery case 1 is crimped onto the sealing plate 2 with a gasket 3 interposed therebetween. Thus, a battery is produced.

The foregoing has been described in the context of a cylindrical non-aqueous secondary battery, but the battery shape is not limited thereto, and can be rectangular or any other shape.

### EXAMPLE

### Example 1

### (1) Production of Positive Electrode

A positive electrode active material in an amount of 100 parts by weight was mixed with 3 parts by weight of acetylene black as a conductive material and a solution prepared by dissolving 4 parts by weight of polyvinylidene fluoride (PVDF) as a binder in N-methyl-2-pyrrolidone (NMP), and thereby a positive electrode material mixture paste was obtained. As the positive electrode active material, lithium cobalt oxide was used. The positive electrode material mixture paste was intermittently applied onto both surfaces of a current collector as shown in FIG. 1A, which was then dried and rolled to form a positive electrode continuum. Subsequently, the positive electrode continuum was cut into a predetermined size to obtain strip-shaped positive electrodes. As the positive electrode current collector, an aluminum foil having a thickness of 15 μm was used. The total thickness of the positive electrode material mixture layers formed on both surfaces of the current collector and the current collector was 165 μm.

### (2) Production of Negative Electrode

Artificial flake graphite was pulverized and sized to have an average particle size of 20 μm, and thereby a negative electrode active material was obtained. The negative electrode active material in an amount of 100 parts by weight was mixed with 1 part by weight of styrene/butadiene rubber as a binder and 100 parts by weight of an aqueous solution containing 1 wt % of carboxymethyl cellulose, and thereby a negative electrode material mixture paste was obtained. The negative electrode material mixture paste was applied onto both surfaces of a current collector, which was then dried, rolled and cut into a predetermined size. In this manner, a strip-shaped negative electrode was obtained. As the negative electrode current collector, a copper foil having a thickness 10 μm was used. The total thickness of the negative electrode material mixture layers formed on both surfaces of the current collector and the current collector was 155 μm.

### (3) Formation of Insulating Layer

An insulating layer paste was prepared by mixing 970 g of alumina having a median diameter of 0.3 μm, 375 g of BM-720H (solid content: 8 parts by weight), a polyacrylonitrile modified rubber binder available from Zeon Corporation, Japan, and an appropriate amount of NMP using a double arm kneader. The positive electrode was dipped in the insulating layer paste, and then dried to form second insulating layers on both longitudinal end faces of the positive electrode. The second insulating layer had a thickness of around 1 μm.

### (4) Preparation of Non-Aqueous Electrolyte

A mixed solution was obtained by adding 1 wt % of vinylene carbonate to a solvent mixture of ethylene carbonate and ethyl methyl carbonate mixed at a volume ratio of 1:3. Then, LiPF₆ was dissolved in the mixed solution such that the LiPF₆ concentration was 1.0 mol/L, and thereby a non-aqueous electrolyte was obtained.

### (5) Production of Cylindrical Battery

An end of an aluminum positive electrode lead 5a was attached to the current collector of a positive electrode 5. Likewise, an end of a nickel negative electrode lead 6a was attached to the current collector of a negative electrode 6. These electrode plates were spirally wound with a porous resin film 7 serving as a first insulating layer interposed therebetween, and thereby an electrode group was obtained. As the porous resin film, a polyethylene microporous sheet-like film was used. The electrode group was inserted into a battery case 1, and an upper insulating plate 8a and a lower insulating plate 8b were placed on the upper and lower portions of the electrode group, respectively. The other end of the negative electrode lead 6a was connected to the inside of the battery case 1. The other end of the positive electrode lead 5a was welded to a sealing plate 2 equipped with an internal-pressure activated safety valve. Subsequently, a non-aqueous electrolyte was injected into the battery case 1 with a reduced-pressure method. The opening edge of the battery case 1 was crimped onto the sealing plate 2 with a gasket 3 interposed therebetween. Thus, a battery was produced.

### Example 2

A battery was produced in the same manner as in EXAMPLE 1, except that third insulating layers were formed on both widthwise end faces of a positive electrode using an insulating layer paste having the same composition as that prepared in EXAMPLE 1. The third insulating layer was formed by dipping, similar to the second insulating layer. The third insulating layer had a thickness of around 1 μm.

### Example 3

A battery was produced in the same manner as in EXAMPLE 1, except that inorganic oxide particle films were formed on both surfaces of a positive electrode, as shown in FIG. 1C, using an insulating layer paste having the same composition as that prepared in EXAMPLE 1. The inorganic oxide particle film had a thickness of 4 μm. The inorganic oxide particle film was formed using a gravure roll.

### Example 4

A battery was produced in the same manner as in EXAMPLE 1, except that a polyethylene microporous sheet-like film was not used, inorganic oxide particle films were formed on both surfaces of a positive electrode using a paste having the same composition as that prepared in EXAMPLE 1, and third insulating layers were formed on both widthwise end faces of the positive electrode in the same manner as in EXAMPLE 2. The inorganic oxide particle film had a thickness of 20 μm.

### Comparative Example 1

A battery was produced in the same manner as in EXAMPLE 1 except for the following. The second insulating layer was not formed, and inorganic oxide particle films were formed on both surfaces of a positive electrode using an insulating layer paste having the same composition as that prepared in EXAMPLE 1 in the same manner as in EXAMPLE 3. An electrode group was produced by spirally winding the positive electrode on which the inorganic oxide particle films were formed, a negative electrode and a polyethylene microporous film. The bottom faces of the obtained electrode group were dipped in the insulating layer paste for insulating treatment.

### Comparative Example 2

A battery was produced in the same manner as in EXAMPLE 1, except that the inorganic oxide particle film and the second insulating layer were not formed, and third insulating layers were formed on both widthwise end faces of a positive electrode using an insulating layer paste having the same composition as that prepared in EXAMPLE 1 in the same manner as in EXAMPLE 2.

### Comparative Example 3

A battery was produced in the same manner as in EXAMPLE 1, except that the second insulating layer was not formed, inorganic oxide particle films were formed on both surfaces of a positive electrode using an insulating layer paste having the same composition as that prepared in EXAMPLE 1 in the same manner as in EXAMPLE 3, and third insulating layers were formed on both widthwise end faces of the positive electrode in the same manner as in EXAMPLE 2.

### Comparative Example 4

A battery was produced in the same manner as in EXAMPLE 1 except for the following. The polyethylene microporous film was not used, and the second insulating layer was not formed, either. Inorganic oxide particle films were formed on both surfaces of a positive electrode using an insulating layer paste having the same composition as that prepared in EXAMPLE 1. The inorganic oxide particle film had a thickness of 20 μm.

### Comparative Example 5

A battery was produced in the same manner as in EXAMPLE 1 except for the following. The polyethylene microporous film was not used, and the second insulating layer was not formed, either. Inorganic oxide particle films were formed on both surfaces of a positive electrode using an insulating layer paste having the same composition as that prepared in EXAMPLE 1. In addition, third insulating layers were formed on both widthwise end faces of the positive electrode in the same manner as in EXAMPLE 2. The inorganic oxide particle film had a thickness of 20 μm.

### Comparative Example 6

A battery was produced in the same manner as in EXAMPLE 1, except that second insulating layers were formed on both longitudinal end faces of a positive electrode by, instead of applying an insulating layer paste, using insulation tape. As the insulation tape, insulation tape (product number: 4663) available from Teraoka Seisakusho Co., Ltd. was used.

The configuration of each battery and the result thereof are shown in Tables 1 and 2.

TABLE 1

| | | | | | Insulating |
|---|---|---|---|---|---|
| | | First | Second | Third | treatment of |
| | Microporous | insulating | insulating | insulating | electrode |
| | film | layer | layer | layer | group |
| Ex. 1 | Yes | No | Yes | No | No |
| Ex. 2 | Yes | No | Yes | Yes | No |
| Ex. 3 | Yes | Yes | Yes | No | No |
| Ex. 4 | No | Yes | Yes | Yes | No |
| Comp. | Yes | Yes | No | No | Yes |
| Ex. 1 | | | | | |
| Comp. | Yes | No | No | Yes | No |
| Ex. 2 | | | | | |
| Comp. | Yes | Yes | No | Yes | No |
| Ex. 3 | | | | | |
| Comp. | No | Yes | No | No | No |
| Ex. 4 | | | | | |
| Comp. | No | Yes | No | Yes | No |
| Ex. 5 | | | | | |
| Comp. | Yes | No | Yes | No | No |
| Ex. 6 | | | (Insulation | | |
| | | | tape) | | |

TABLE 2

| | | Occurrence of internal short |
|---|---|---|
| | Permeability | circuit after drop test |
| | (min.) | (Number of batteries) |
| Ex. 1 | 5 | 0/1000 |
| Ex. 2 | 5 | 0/1000 |
| Ex. 3 | 6 | 0/1000 |
| Ex. 4 | 6 | 0/1000 |
| Comp. Ex. 1 | 45 | 2/1000 |
| Comp. Ex. 2 | 4 | 8/1000 |
| Comp. Ex. 3 | 5 | 7/1000 |
| Comp. Ex. 4 | 5 | — |
| Comp. Ex. 5 | 5 | — |
| Comp. Ex. 6 | 20 | 0/1000 |

As is apparent from Table 2, the battery of EXAMPLE 1 in which the longitudinal end faces of the positive electrode were coated with a second insulating layer exhibited significantly improved permeability of non-aqueous electrolyte into the electrode group as compared to the battery of COMPARATIVE EXAMPLE 1 in which the bottom faces of the electrode group were treated for insulation. This is presumably because the upper and lower bottom faces of the electrode group were all coated with the insulating layer in the battery of COMPARATIVE EXAMPLE 1, whereas in the battery of EXAMPLE 1, only the longitudinal end faces of the positive electrode were coated with the second insulating layer.

For the batteries of EXAMPLES 1 to 4 in which the longitudinal end faces of the positive electrode were coated with a second insulating layer, the occurrence of internal short circuit after drop test was suppressed as compared to the batteries of COMPARATIVE EXAMPLES 1 to 3 in which no second insulating layer was formed. This is presumably because the longitudinal end faces of the positive electrode were coated with the second insulating layer, and as a result, the end faces of the positive electrode did not come into contact with the negative electrode even when the positive electrode and the negative electrode moved out of position with each other in the electrode group after being dropped. As for the batteries of COMPARATIVE EXAMPLES 4 and 5, they were not able to perform charging and discharging. The battery of COMPARATIVE EXAMPLE 6 exhibited a lower permeability of non-aqueous electrolyte into the electrode group because the longitudinal end faces of the positive electrode were coated with insulation tape that was not porous.

According to the present invention, it is possible to provide a non-aqueous secondary battery that has both high productivity and excellent safety. The non-aqueous secondary battery described above is useful as a power source for electronic devices such as notebook computers, mobile phones and digital still cameras, as well as electric power storage and electric vehicle power source applications requiring high output.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications that fall within the true spirit and scope of the invention.

1. A non-aqueous secondary battery comprising a strip-shaped positive electrode, a strip-shaped negative electrode, a first insulating layer interposed between said positive electrode and said negative electrode, and a non-aqueous electrolyte,
wherein the width of said positive electrode is smaller than the width of said negative electrode,
both longitudinal end faces of said positive electrode are coated with a second insulating layer, and
said first insulating layer and said second insulating layer are both porous.

2. The non-aqueous secondary battery in accordance with claim 1,
wherein said first insulating layer comprises at least one selected from a porous resin film and an inorganic oxide particle film,
said inorganic oxide particle film comprises an inorganic oxide particle and a binder, and
said inorganic oxide particle film is attached to both surfaces of said positive electrode.

3. The non-aqueous secondary battery in accordance with claim 2,
wherein said first insulating layer comprises both said inorganic oxide particle film and said porous resin film.

4. The non-aqueous secondary battery in accordance with claim 1,
wherein at least one of the widthwise end faces of said positive electrode is coated with a third insulating layer.

5. The non-aqueous secondary battery in accordance with claim 4,
wherein at least one of said second insulating layer and said third insulating layer contains the same material as the constituent material of said inorganic oxide particle film.

6. The non-aqueous secondary battery in accordance with claim 4,
wherein said third insulating layer comprises insulation tape.

7. The non-aqueous secondary battery in accordance with claim 1,
wherein said negative electrode contains, as a negative electrode active material, at least one selected from the group consisting of silicon, a silicon alloy, a silicon oxide and a silicon nitride.

8. A method for producing a non-aqueous secondary battery comprising the steps of:
(i) intermittently forming positive electrode material mixture layers on both surfaces of a positive electrode current collector sheet to form a positive electrode continuum;
(ii) applying a first paste containing an inorganic oxide particle, a binder and a liquid component on a surface of said positive electrode material mixture layers, followed by drying to remove the liquid component to form a first insulating layer;
(iii) cutting said positive electrode continuum to obtain a strip-shaped positive electrode;
(iv) coating both longitudinal end faces of said positive electrode with a second insulating layer; and
(v) laminating or spirally winding said positive electrode having the first insulating layer and the second insulating layer and a negative electrode with said first insulating layer interposed therebetween to form an electrode group.

9. The method for producing a non-aqueous secondary battery in accordance with claim 8,
wherein said step (iv) includes forming said second insulating layer with a second paste containing the same material as the constituent material of said first paste.

10. The method for producing a non-aqueous secondary battery in accordance with claim 9,
wherein said second paste contains said binder at a content higher than said first paste.

11. A method for producing a non-aqueous secondary battery comprising the steps of:
(a) intermittently forming positive electrode material mixture layers on both surfaces of a positive electrode current collector sheet to form a positive electrode continuum;
(b) cutting said positive electrode continuum to obtain a strip-shaped positive electrode;
(c) applying a paste containing an inorganic oxide particle, a binder and a liquid component onto said positive electrode such that the application width is larger than the width of said positive electrode, followed by drying to remove the liquid component so as to coat both surfaces of said positive electrode and both longitudinal end faces of said positive electrode with a first insulating layer and a second insulating layer, respectively; and
(d) laminating or spirally winding said positive electrode having the first insulating layer and the second insulating layer and a negative electrode with said first insulating layer interposed therebetween to form an electrode group.

12. The method for producing a non-aqueous secondary battery in accordance with claim 8, further comprising a step X of further coating at least one of the widthwise end faces of said positive electrode with a third insulating layer.

13. The method for producing a non-aqueous secondary battery in accordance with claim 11, further comprising a step X of further coating at least one of the widthwise end faces of said positive electrode with a third insulating layer.

14. The method for producing a non-aqueous secondary battery in accordance with claim 12,
wherein said step X includes coating said widthwise end face with insulation tape to form said third insulating layer.

15. The method for producing a non-aqueous secondary battery in accordance with claim 13,
wherein said step X includes coating said widthwise end face with insulation tape to form said third insulating layer.
